(19) United States
(12) Patent Application Publication
(10) Pub. No.: US 2004/0088210 A1
(43) Pub. Date: May 6, 2004

(54) Methods and systems for integrating human and electronic channels

(76) Inventor: Igor Tsyganskiy, Los Gatos, GA (US)

Correspondence Address: Finnegan, Henderson, Farabow,, Garrett & Dunner, L.L.P., 1300 I Street, N.W., Washington, DC, 20005-3315, US

(21) Appl. No.: 10/286,038

(22) Filed: Nov. 1, 2002

(51) Int. Cl. G06F 17/60

(52) U.S. Cl. 705/10

(57) ABSTRACT

Disclosed are techniques for integrating human channels and electronic channels. To facilitate such integration user-intent is determined based on user interaction with a human-channel and an e-channel. Information for the user is tailed tailored based on the determined user-intent.

### FIELD

This invention relates generally to the field of sales management, and, more particularly, to methods and systems for integrating human and electronic sales channels.

### BACKGROUND

The Internet, fueled by the phenomenal popularity of the World Wide Web (the “Web”), has exhibited exponential growth over the past few years. On the Web, the ease of self-publication via user-created “Web pages” has helped generate tens of millions of documents on a broad range of subjects, all capable of being displayed to a user with access to the Web.

Users can access information on the Web using standard computer equipment, such as a personal computer with a display and modem connected to the Internet. Several types of Internet connections are available, including connections through Internet Service Providers (ISPs). To use an Internet connection from an ISP, for example, a user can electronically connect his personal computer to a server at the ISP's facility using a modem and a standard telephone line or a local area network (LAN) connection. The ISP's server in turn provides the user with access to the Internet.

Typically, a user accesses information on the Internet using a computer program called a “Web browser. ” A Web browser provides an interface to the Web. Examples of Web browsers include Netscape Navigator™ from Netscape Communications Corporation or Internet Explorer™ from Microsoft Corporation. To view a Web page, the user enters the Web page's Uniform Resource Locator (URL) address to instruct the Web browser to access the Web page. Via the Web browser, the user can view or access an object in the Web page, such as a document containing information of interest. The Web browser retrieves the object and visually displays it to the user.

Computers may facilitate electronic commerce (E-commerce) over the Internet, such as online sale of goods, electronic funds transfer, online advertising, and access to business information resources. E-commerce has the potential to improve the efficiency of current business processes and provide opportunities to widen existing customer bases. Consequently, E-commerce has the potential to be the source of an extraordinary amount of revenue growth.

E-commerce solutions, such as electronic channels (e-channels), however, do not fully facilitate business transactions. Instead, customers may rely on human-channels to facilitate business transactions. In particular, they rely on existing relationships and knowledge held in a human-channel. In other cases, the e-channel interaction fails to provide the incentive for a business transaction that a human-channel could provide.

On the other hand, integrated e-channels and human-channels have the potential to facilitate business transactions and consequently increase revenue and decrease business costs. In order to realize this potential, however, business processes and components must leverage that which traditionally was available in human-sales channels. For instance, a directed sales force coordination of human and e-channels could provide a more in-depth understanding of customer desires and facilitate customer support. Furthermore, such coordination could aid in determining customer sales patterns. Thus, an integrated link between the human-channel and the e-channel of customer sales is needed.

### SUMMARY

Consistent with the invention, a method is presented for integrating human and electronic sales channels. The method comprises determining user-intent based on user interaction with a human-channel and an e-channel and tailoring information for the user based on determined user-intent.

Other features and advantages of the invention will be apparent from the accompanying drawings, and from the detailed description, which follow below.

### BRIEF DESCRIPTION OF THE DRAWINGS

The accompanying drawings, which are incorporated in and constitute a part of this specification, together with the description, serve to explain the principles of the invention. In the drawings:

FIG. 1 is a block diagram of an exemplary system architecture in which the invention may be implemented;

FIG. 2 is an internal block diagram of an exemplary computer system in which methods and systems consistent with the invention may be implemented;

FIG. 3 is detailed block diagram of components of the system from FIG. 1;

FIG. 4 is a flow diagram of a method for integrating e-channels and human-channels for existing customers;

FIG. 5 is a flow diagram of a method for integrating e-channels and human-channels for potential customers; and

FIG. 6 is a flow diagram of a method for extracting user information.

### DETAILED DESCRIPTION

Reference will now be made in detail to implementation of the invention. Techniques are disclosed for integrating the human-channel and the electronic channel to better assist a supplier in targeting a customer. Currently, a limited number of people from a customer company are directly involved with human-channel negotiations with a supplier. Others from the customer company may gather and request information from an e-channel. In some cases, an e-channel is visited first, often to gather information about the supplier, before interaction with a human-channel.

In one implementation, an integration module correlates the information provided by these different channels. For instance, the integration module may determine the information accessed by a potential customer on an e-channel and relay this information to the human channel. The integration module may also receive information from the human-channel and display it to an existing customer through an e-channel. Thus, this integrated channel facilitates communication between a company and a customer. Furthermore, it can facilitate both monitoring of current customers and charting of prospective customers, e.g., prospect companies.

The following implementations are described for a sales service application. Nevertheless, the following implementations can be implemented for other types of service applications, such as, for example, marketing applications, advertising applications or other like applications.

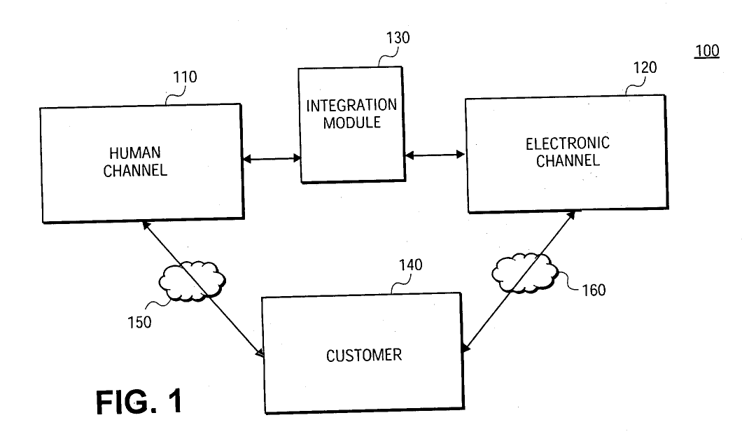

FIG. 1 is block diagram of an exemplary system architecture 100 in which the disclosed techniques may be implemented. System architecture 100 includes a human-channel 110 connected by a communication link 150 to a customer 140. The customer 140 is connected by network 160 to e-channel 120. Integration module 130 connects human-channel 110 and e-channel 120.

Customer 140 may be an individual or a corporation. In one embodiment, customer 140 is defined by matching the IP address of the request with the IP addressed stored in the sellers database. In another embodiment, customer 140 is defined by matching the hostname of the request with a registered domain name of a customer. In yet another embodiment, customer 140 may be a cookie uniquely identifying the request with a customer.

Human-channel 110 is a communication channel between human controlled sales people and customer 140. Human-channel 110 may include telephone inquiries, presentations made to customers, telephone follow-up calls to customers, samples provided to customers, personal relationships developed with customers, or other like communications. Human-channel 110 can function with an asymmetrical and non-linear flow of requests and responses where no protocol limits or directs the communication. This type of flow refers to requests and responses that may cover a variety of personal and non-business subject matter in a non-directed approach. The content provided by human-channel 110 can be dependent upon numerous factors including questions asked by a customer, brochures available on different topics, and company policies, e.g., policy to provide samples or demonstrations of products. Customer responses to communications facilitated by human-channel 110 are used to understand the intent of customer 140.

E-channel 120 is the E-commerce driven sales channel that communicates with customer 140. The communication may take place over network 160, such as the Internet, a wide area network (WAN), a local area network (LAN) or a proprietary network. Communication between e-channel 120 and customer 140 through network 160 are a symmetrical and synchronous. This flow includes requests and responses driven by the customer. For example, a customer initiates a request from the e-channel and receives an associated response. The content customer 140 views from the e-channel may be a set of fixed information, not specifically tailored to a customer. Through its interactions with the fixed e-channel 120, customer 140 reveals the their intent or purchasing desires, which can be targeted by the human channel.

Integration module 130 is a computing device that allows human-channel 110 to access information gathered from e-channel 120 interaction with customer 140. For instance, human-channel 110 may access information revealing the intent of customer 140, as well as the needs of an existing or prospective customer. Integration module 130 further allows human-channel 110 to manipulate the fixed content in e-channel 120. For instance, human-channel 110 may manipulate e-channel content to relay a message directed to a specific customer. Also, the integration channel may automatically tailor content based on information gathered from the human-channel and the e-channel.

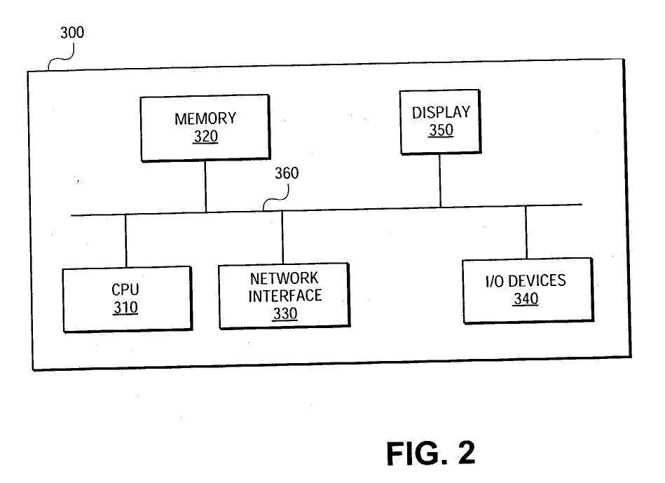

FIG. 2 is an internal block diagram of an exemplary computer system 300 for implementing the techniques disclosed herein. Computer system 300 may represent, for example, the internal components of parts of integration module 130 in FIG. 1 or computing device used by customer 140. Such techniques for integration module 130 are described in further detail below.

Computer system 300 may be, for example, a conventional personal computer (PC), a desktop and hand-held device, a multiprocessor computer, a pen computer, a microprocessor-based or programmable consumer electronics, a minicomputer, a mainframe computer, a personal mobile computing device, a mobile phone, a portable or stationary personal computer, a palmtop computer or other known computers.

Computer system 300 includes a CPU 310, a memory 320, a network interface 330, I/O devices 340, and a display 350, that are all interconnected via a system bus 360. As shown in FIG. 2, computer system 300 contains a central processing unit (CPU) 310. CPU 310 may be a microprocessor such as the Pentium® family of microprocessors manufactured by Intel Corporation. However, any other suitable microprocessor, micro-, mini-, or mainframe computer may be used, such as a micro-controller unit (MCU), digital signal processor (DSP).

Memory 320 may include a random access memory (RAM), a read-only memory (ROM), a video memory, mass storage, or cache memory such as fixed and removable media (e.g., magnetic, optical, or magnetic optical storage systems or other available mass storage technology).

Memory 320 stores support modules such as, for example, a basic input output system (BIOS), an operating system (OS), a program library, a compiler, an interpreter, and a text-processing tool. Support modules are commercially available and can be installed on computer 300 by those of skill in the art. For simplicity, these modules are not illustrated. Furthermore, memory 320 may contain an operating system, an application routine, a program, an application-programming interface (API), and other instructions for performing the techniques disclosed herein.

Network interface 330, examples of which include Ethernet or dial-up telephone connections, may be used in association with e-channel 120. Computer system 300 may also receive input via input/output (I/O) devices 340, which may include a keyboard, pointing device, or other like input devices. Computer system 300 may also present information and interfaces via display 350 to a customer.

Bus 360 may be a bidirectional system bus. For example, bus 360 may contain thirty-two address bit lines for addressing a memory 320 and thirty-two bit data lines across which data is transferred among the components. Alternatively, multiplexed data/address lines may be used instead of separate data and address lines.

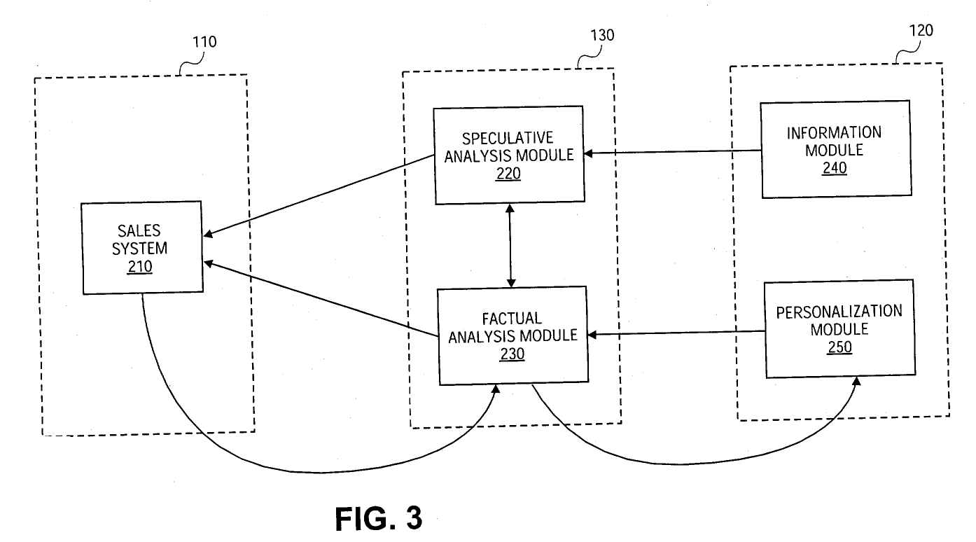

FIG. 3 is block diagram of an exemplary interaction between integration module 130, human-channel 110, and e-channel 120. Integration module 130 includes speculative analysis module 220 and factual analysis module 230 to facilitate the integration. E-channel 120 contains information module 240 and personalization module 250. Information module 240 gathers customer information based on a visit to a web site. Personalization module 250 publishes information to be displayed to a customer. In another embodiment, personalization module 250 may also track customer interaction with the site. The modules in e-channel 120 may send information to integration module 130. In one embodiment the interaction between modules and the system may be written in a programming language, such as Java™, C, C++ or any other high level programming language.

Integration module 130 contains speculative analysis module 220 and factual analysis module 230, which receive information from information module 240 and personalization module 250, respectively. Speculative analysis module 220 and factual analysis module 230 can be software stormed in memory 320 and executed by CPU 310 of FIG. 2. In another embodiment, speculative analysis module 220 and factual analysis module 230 may be computing systems or hardware programmed to implement integration. In yet another embodiment, the actions of speculative analysis module 220 and factual analysis module 230 may be performed by humans.

Speculative analysis module 220 gathers information about customers who interact with e-channel 120 and analyzes this information to determine user intent or intent information. The intent information is then sent to factual analysis module 230 and sales system 210. Intent may be derived from the actions taken by a user at the e-channel. These actions may include requests made to a web site, time spent on a particular web page, and pages visited.

Human-channel 110 may use a sales system 210 and provide data to it based on interactions with existing customers. Examples of sales system 210 include Sales Force Automation (SFA) systems. SFA systems use technology to help automate, organize, and track the selling process, as a means of increasing sales efficiency and effectiveness. Sales system 210 may also receive and send information to factual analysis module 230. The information sent to factual analysis module 230 defines the human-channel content to publish to the user.

Factual analysis module 230 receives data from sales system 210, personalization module 250, and speculative analysis module 220. This data includes information relating to customer 140 interactions with both the human-channel and e-channel. This information may be used with other received information to instruct personalization module 250, e.g., content to publish to customer 140.

The system gathers information about customers who interact with e-channels. For instance, information module 240 gathers information from customer 140's interaction with an e-channel web site. In one embodiment e-channel 120 tracks user activity, through the use of a HTTP cookie. E-channel 120 logs information about visitors, such as Host IP, URL or Alias, Referrer, Selective Get or Post Data, User and Session IDs. A session ID cookie, which expires upon the end of a user session, through the use of HTTP cookie or unique URL, is used. In another embodiment, information module 240 sends the log information to speculative analysis module 220. In yet another embodiment, information module 240 consists of multiple parts. One part, such as a J2EE filter or ISAPI filter, tracks basic information about a user session, i.e. content requested, content sent, time, cookie context, HTTP status codes, URLs, or other HTTP header information. The other part reads application specific business information and be integrated and designed specifically with the application in mind.

Speculative analysis module 220 gathers data about a prospective customer who interacts with an e-channel. This data may include, for example: an aggregation of all URLs or aliases for a particular hostname; number of visits to an e-channel; average time spent on a page or screen; and calculation of penetration index, where the penetration index represents the depth of a customer's browsing. This material may also be filtered. In one embodiment, speculative analysis module 220 creates internal statistics on the use of a site including the average use of a site by a customer, the average use of a site by a potential customer, the average number of mistaken hits to a site. Furthermore, these internal statistics may be compared to customer data.

In one embodiment, speculative analysis module 220 processes a request by customer 140 and determines from it information about the customer, such as host IP, URL or Alias, Referrer, User or Session ID. The request may use a standard Hypertext Markup Transfer Protocol (HTTP). Speculative analysis module 220 can process the request information and send it to sales system 210 or factual analysis module 230. With the received request information, factual analysis module 230 can monitor items ordered by a customer and update sales system 210 to reflect customer actions.

Based on gathered customer information, the system provides personalized information to the customer. This information includes the following: “panels” of information; natural language query functionality, where human-channel employees have generated answers to natural language questions; and other types of informational or transactional service. This may be facilitated through the use of a set of predefined groups of panels available to the sales force. For instance, the sales person in the human-channel may choose panels to be “served” to specific prospect organizations. The sales person may also modify values contained in the panels. By measuring a customer or an organization's reaction to specific panels or sales presentations, a customer's specific “wants,” “needs,” or intent, are exposed.

In one embodiment, factual analysis module 230 determines the content of the response to a customer request. For instance, factual analysis module 230 may provide a focused web page, or panel, that is tailored to the specific customer making a request. Factual analysis module 230 may also modify a fixed web page, such that it is tailored to the customer. In another embodiment, factual analysis module may provide “focused” panels to a prospective customer. The data provided by factual analysis module 230 is sent to personalization module 250 for publication.

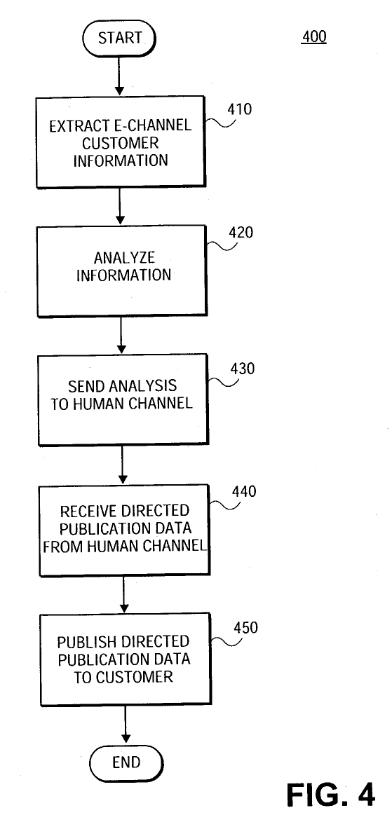

FIG. 4 is a flow diagram of a method 400 for integrating e-channels and human-channels for existing customers. First, information about a customer is extracted from the e-channel (step 410). Next, this information is analyzed (step 420), e.g., by the speculative analysis module 220 of FIG. 3. The analyzed information is sent to the human-channel (step 430). Examples of such information include products/services a customer may be interested in, how much money the customer may be willing to spend, aggregate interest of a given customer to a specific product offering. Based on this information, the human-channel sends directed publication data to the integration module (step 440). This directed publication data may be information based on prior experience with the customer, hot items from the marketing department, general company direction, and etc. The factual analysis module 230 integrates the human-channel suggestions with the e-channel formats and other suggestions. Finally, the directed publication data is published to the customer (step 450). Publication includes the creation of a directed web page. In one embodiment, the directed web page may contain favorites (items a customer often orders or views), new order, order history (items recently ordered by a customer), supplier recommendation, or frequently viewed items. In another embodiment, the directed web page may be personalized for the specific customer.

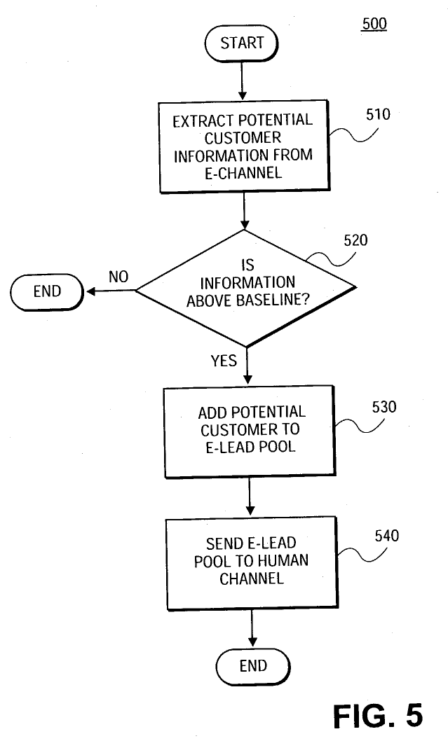

FIG. 5 is a flow diagram of a method 500 for integrating e-channels and human-channels for prospective or potential customers. When a prospective customer visits an e-channel, the e-channel can gather information about the new prospect (step 510). For instance, user information may be extracted from a web page visited by the potential customer. In one embodiment, the extracted information is used to create a set of interest information. The interest information is analyzed to determine if the interest from the customer is greater than a baseline, e.g., the average use of a site by a potential customer (step 520). The process ends if the information is not above the baseline. In one embodiment, the e-channel indicates a potential customer who visits a site more than the baseline. In another embodiment, the e-channel indicates level and type of interest expressed online for offered products and services. If the potential customer falls above the baseline, then the customer may be added to an electronic lead (e-lead) pool (step 530). The e-lead pool identifies prospective customers. The e-lead information is then sent to the human-channel (step 540).

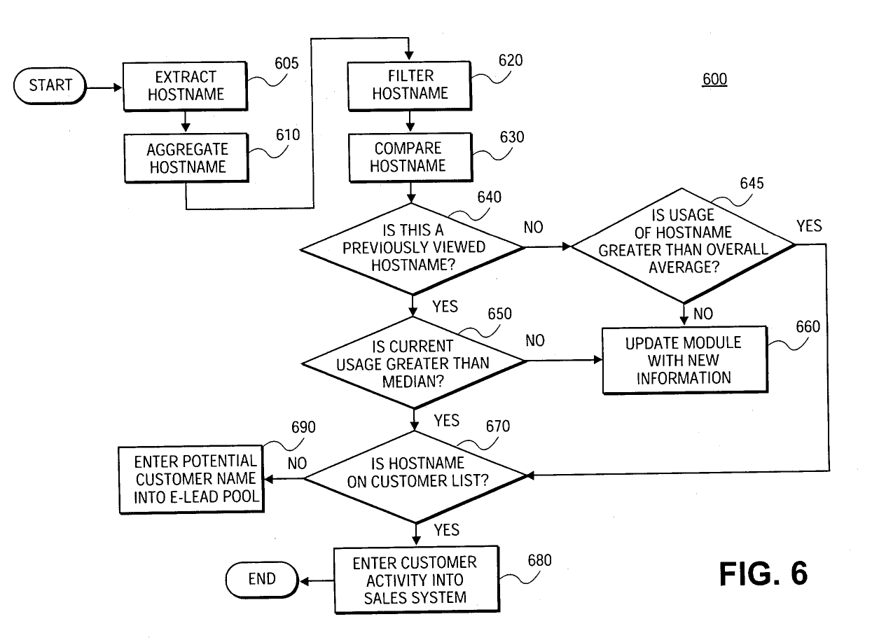

FIG. 6 is a flow diagram of a method 600 for extracting user information, through speculative analysis. When an e-channel user visits an e-channel, the user hostname is extracted (step 605). The hostname may be extracted from web logs or request header information. The hostnames are aggregated to create a list of hostnames (step 610). Integration module 130 may load competitor and partner hostnames and filter the aggregated hostnames to separate competitor and partner hostnames. The use of a website by a competitor, as indicated by the competitor hostname, may be tracked to gather an indication of competitor interests or concerns.

The filtered hostname is compared with data (step 630). This data may be statistical data, which includes a historical record of visits from a particular user or user's company. The data may also indicate if the company associated with a hostname is already a customer.

Integration module 130 checks if a user from the hostname has visited the site before (step 640). If the hostname is an unknown hostname, then the module checks if the usage by the hostname is greater than a median usage calculated by the internal statistics of speculative analysis module 220 (step 645). If the usage is less than the median, then integration module 130 will be updated with the visit information (step 660). If, however, the hostname is a previously viewed hostname, integration module 130 checks if the current usage is greater than the median usage of the specific hostname (step 650). If usage is less than the median usage, integration module 130 will be updated with the visit information (step 660).

If, instead, usage is greater than median usage, for either an unknown hostname or a tracked hostname, then the system checks if the hostname is on a customer list (step 670). If the hostname is associated with a customer, then the customer's activity is entered into the sales system (step 680). Once the information is entered into the sales system, the human-channel can use that information to contact the customer. If the hostname is not associated with a customer, then the hostname will be entered into a potential customer e-lead pool (step 690).

While embodiments or features of the invention have been described as being stored in memory, one skilled in the art will appreciate that these aspects can also be stored on or read from other types of computer-readable media, such as secondary storage devices, like hard disks, floppy disks, or CD-ROMs; a carrier wave from the Internet; or other forms of RAM or ROM. Similarly, the exemplary methods disclosed herein and other embodiments of the invention may conveniently be implemented in program modules that are based upon the flow charts in FIGS. 4-6. No particular programming language has been indicated for carrying out the various procedures described above because it is considered that the operations, stages and procedures described above and illustrated in the accompanying drawings are sufficiently disclosed to permit one of ordinary skill in the art to practice embodiments of the invention. Moreover, there are many computers and operating systems that may be used in practicing the invention and therefore no detailed computer program could be provided which would be applicable to these many different systems. Each user of a particular computer will be aware of the language and tools which are most useful for that user's needs and purposes.

Furthermore, the above-noted features and embodiments of the present invention may be implemented in various environments. Such environments and related applications may be specially constructed for performing the various processes and operations of embodiments of the invention or they may include a general-purpose computer or computing platform selectively activated or reconfigured by program code to provide the necessary functionality. The exemplary processes disclosed herein are not inherently related to any particular computer or other apparatus, and aspects of these processes may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Embodiments of the present invention also relate to computer readable media that include program instructions or program code for performing various computer-implemented operations based on the methods and processes of the invention. The program instructions may be those specially designed and constructed for the purposes of implementing embodiments of the invention, or they may be of the kind well known and available to those having skill in the computer software arts. Examples of program instructions include for example machine code, such as produced by a compiler, and files containing a high level code that can be executed by the computer using an interpreter.

Other embodiments of the invention are apparent from consideration of the specification and practice of the exemplary embodiments disclosed herein. Therefore, it is intended that the specification and examples be considered as exemplary only, with a true scope and spirit of the invention being indicated by the scope of the following claims and their equivalents.

What is claimed is:

1. A method comprising:
integrating data about user interaction with a human-channel and an e-channel;
determining user-intent based on user interaction with the human-channel and the e-channel; and
tailoring information for the user based on determined user-intent.

2. A method for coordinating user data from an e-channel and user information from a human channel, the method comprising:
extracting user data from the e-channel;
analyzing the extracted user data;
determining user intent based on the analyzed data;
receiving information from the human channel based on human interaction with the user; and
tailoring a publication for the user based on the received information and analyzed data.

3. The method of claim 2 wherein the user data is based on prior interaction with the e-channel by the user.

4. The method of claim 2 wherein analyzing the extracted user data further comprises:
determining the identity of the user; and
determining the frequency of use of the e-channel based on the user identity.

5. The method of claim 2 wherein determining user intent is based on prior interactions between the user and the e-channel.

6. A method comprising:
receiving data from an e-channel based on a user's request, wherein the data indicates a user intent and user identity;
determining a response to the user based on the user intent and identity; and
sending instructions based on the determined response.

7. A method of 6 further comprising:
publishing the determined response in an e-channel.

8. A method of 6 further comprising:
contacting the user based on the determined content at the human channel.

9. A method comprising:
receiving a user request from an e-channel;
detecting the user interest based on the received user request;
receiving publication data from a human-channel based on the detected user interest; and
responding to the user request based on the publication data.

10. A method for determining prospective customers based on visits to an e-channel, comprising:
determining the identity of a user based on request header or web log information; and
determining the frequency of visits to the e-channel based on the identity of the user; and
adding the user to a prospective customer list if the frequency of visits is greater than a baseline.

11. The method of claim 10 further comprising:
sending the prospective customer list to a human-channel.

12. A method for tracking prospective customers using an e-channel comprising:
determining if a user of an e-channel is a prospective customer;
determining the level of interest of the prospective customer; and
creating a response at the human-channel based on the determined level of interest.

13. The method of claim 12 wherein determining a prospective customer further comprises extracting hostnames from an electronic request for information made by a user.

14. The method of claim 12 wherein the level of interest is determined by checking for prior use of the e-channel by the prospective customer.

15. The method of claim 14 wherein the prior use by the prospective customer is greater than a baseline.

16. A method for facilitating business transactions comprising:
extracting data based on use of an e-channel by a user;
creating user-intent-data based on the extracted data;
sending user-intent-data to a human channel; and
using the intent data to facilitate business transactions.

17. A system for coordinating user data from an e-channel and user information from a human channel, the system comprising:
an integration module connecting the e-channel and the human channel, wherein the integration module comprises a speculative analysis module and a factual analysis module;
means for extracting user data from the e-channel, wherein the speculative analysis module analyzes the user data to determine user intent;
means for receiving information from the human channel based on one or more of, the determined user intent, and user information form a human channel, wherein the factual analysis module tailors a publication for the user based on the received information from at least one of, the human channel and the speculative analysis module.

18. The system of claim. 17 wherein the user data is based on prior interaction with the e-channel by the user.

19. The system of claim 17 wherein the speculative analysis module determines the identity of the user; and determines the frequency of use of the e-channel based on the user identity.

20. The system of claim 17 wherein the speculative analysis module determines user intent based on prior interactions between the user and the human channel.

21. An integration module, comprising:
means for receiving a user request from an e-channel, wherein the request includes data indicating a user intent and user identity;
means for receiving input for responding to the request based on user intent and user identity;
means for determining a response to the user based on the user intent and identity and previous interaction with the user by a human channel; and
means for sending instructions to a personalization module based on the determined response.

22. A system for determining prospective customers based on visits to an e-channel, comprising:
means for determining the habits of a user based on prior visits to the e-channel by the user and the frequency of visits to the e-channel based on the identity of the user; and
means for adding the user to a prospective customer list if the frequency of visits is greater than a baseline.

23. A system for tracking prospective customers using an e-channel comprising:
means for determining if a user of an e-channel is a prospective customer;
means for determining the level of interest of the prospective customer; and
means for creating a response at the human-channel based on the determined level of interest.

24. A system for facilitating business transactions comprising:
an information module for extracting data based on use of an e-channel by a user;
a speculative analysis module for creating user-intent-data based on the extracted data;
a sales system for receiving user-intent-data at a human channel; and
a factual analysis module facilitating business transactions using at least one of the intent data and data from the human channel.

25. A computer-readable medium that stores instructions, which when executed perform steps in a method for coordinating user data from an e-channel and user information from a human channel, the steps comprising:
extracting user data from the e-channel;
analyzing the extracted user data;
determining user intent based on the analyzed data;
receiving information from the human channel based on at least one of, the determined user intent, and information gathered directly by the human channel; and
tailoring a publication for the user based on at least one of the received information and the determined user intent.

26. A computer-readable medium that stores instructions, which when executed perform steps in a method for integrating an e-channel and a human channel, the steps comprising:
receiving data from the e-channel based on a user's request, wherein the data indicates a user intent and user identity;
determining a response to the user based on the user intent and identity; and
sending instructions to the human channel based on the determined response.

27. A computer-readable medium that stores instructions, which when executed perform steps in a method for integrating an e-channel and a human channel, the steps comprising:
receiving a user request from the e-channel;
detecting the user interest based on the received user request;
receiving publication data from the human-channel based on the detected user interest; and
responding to the user request based on the publication data.

28. A computer-readable medium that stores instructions, which when executed perform steps in a method for determining prospective customers based on visits to an e-channel, the steps comprising:
determining the identity of a user; and
determining the frequency of visits to the e-channel based on the identity of the user; and
adding the user to a prospective customer list if the frequency of visits is greater than a baseline.

29. A computer-readable medium that stores instructions, which when executed perform steps in a method for tracking prospective customers using an e-channel, the steps comprising:
determining the identity of a prospective customer;
determining the level of interest of the prospective customer; and
creating a response at the human-channel based on the determined level of intent.

30. A computer-readable medium that stores instructions, which when executed perform steps in a method for facilitating business transactions, the steps comprising:
extracting data based on use of an e-channel by a user;
creating user-intent-data based on the extracted data;
sending user-intent-data to a human channel; and
using the intent data to facilitate business transactions.
